(19) United States
(12) Patent Application Publication
(10) Pub. No.: US 2023/0271727 A1
(43) Pub. Date: Aug. 31, 2023

(54) ATTITUDE ESTIMATION METHOD, TERMINAL, SYSTEM AND COMPUTER-READABLE STORAGE MEDIUM

(71) Applicants: University of Macau, Macau (CN); Instituto Superior Técnico, Lisboa (PT)

(72) Inventors: Joel Oliveira REIS, Macau (CN); Pedro Tiago Martins BATISTA, Lisboa (PT); Carlos Jorge Ferreira SILVESTRE, Macau (CN); Paulo Jorge Coelho Ramalho OLIVEIRA, Lisboa (PT)

(73) Assignees: University of Macau, Macau (CN); Instituto Superior Técnico, Lisboa (PT)

(21) Appl. No.: 17/682,066

(22) Filed: Feb. 28, 2022

(51) Int. Cl. B64G 1/24; B64G 1/28

(52) U.S. Cl. CPC B64G 1/244; B64G 1/288; B64G 2001/245

(57) ABSTRACT

Disclosed are an attitude estimation method, a terminal, a system and a computer-readable storage medium. For the problem of attitude and sensor bias estimation, a cascade solution method is provided. The first part of the cascade is a Kalman filter applied to an LTV system, and the second part of the cascade is a nonlinear attitude observer built in SO(3). In the estimation process, only one constant inertial reference vector needs to be measured explicitly in body-fixed coordinates, and the complexity of the attitude estimation algorithm is greatly simplified by exploiting the geometric relationship between the inertial reference vector and the Earth angular velocity vector. At the same time, the time-varying characteristics of the implemented Kalman filter help to avoid the tedious empirical gain adjustment process that often relies on sets of piecewise constant gains, to improve the convergence speed of the algorithm.

### TECHNICAL FIELD

The present invention relates to the field of attitude estimation, and more particularly, to an attitude estimation method, a terminal, a system and a computer-readable storage medium.

### BACKGROUND

A key problem of dynamic attitude estimation is to describe the rotational motion of a rigid body relative to a given frame of reference. This problem has been paid much attention in many fields, such as navigation of autonomous or manually guided vehicles, tactical missile guidance, alignment of satellites intended to face the Earth, design of filtering methods used to stabilize offshore platforms, etc. Since the development of engineering works in the 60s of the 20th century promoted space exploration, research on attitude estimation has been growing systematically.

The reason for the continuing development of attitude estimation solutions lies not only in the pursuit of implementation of lightweight computational algorithms, but also in the constant need to overcome well-known topological obstacles, the inherent limitations of low-cost strap-down sensors, and/or the need to deal with situations where a particular sensor is considered unreliable, such as the global positioning system (GPS) in underwater areas, or magnetometers in environments with strong magnetic signatures. Aware of these deficiencies, the scientific community has been actively exploring solutions by means of single vector observations in an attempt to simplify the design, and to add operational redundancy. Furthermore, in order to avoid accumulated errors over long periods of time, it is crucial to be able to determine the sensor biases, in particular with respect to gyroscopes, which may affect the feasibility of the solution if they cannot be resolved.

The emergence of advanced sensors such as fiber optic gyroscopes (FOGs) prompted the study of new attitude observers that involve higher precision. However, most of the attitude estimation solutions require explicit measurements of at least two constant inertial reference vectors.

### SUMMARY

The technical problem to be solved by the present invention is to provide an attitude estimation method, a terminal, a system and a computer-readable storage medium, which reduce the complexity of attitude estimation and improve the accuracy of attitude estimation.

In order to solve the technical problem, the invention adopts a technical solution of an attitude estimation method comprising:
collecting body-fixed measurements of the angular velocity of a rigid body and collecting body-fixed measurements of a constant inertial reference vector regarding the same rigid body;
taking the measured values of the angular velocity and the constant inertial reference vector as inputs of a preset Kalman filter, and obtaining an output comprising an estimated bias-corrected body-fixed inertial reference vector, an estimation of the Earth angular velocity expressed in body-fixed coordinates, and two bias offsets associated with the two collectors involved when collecting;
determining the rotation matrix of the rigid body according to the estimated bias-corrected body-fixed inertial reference vector, the estimation of the Earth angular velocity expressed in body-fixed coordinates, the two bias offsets and two preset constant inertial reference vectors.

In order to solve the technical problem, the invention adopts another technical solution of an attitude estimation terminal comprising a memory, a processor and a computer program stored on the memory and executable on the processor, which when executed implements the steps of the above-mentioned attitude estimation method.

In order to solve the technical problem, the invention adopts another technical solution of an attitude estimation system comprising a Kalman filter and an attitude observer established on the special orthogonal group of order three;
the Kalman filter is cascaded with the attitude observer;
the Kalman filter comprises:

$$\{ \begin{matrix}\dot{\hat{x}} ( t ) = A ( t ) \hat{x} ( t ) + B ( t ) u ( t ) + ( t ) ( y ( t ) - C ( t ) \hat{x} ( t ) ) \\ ( t ) = P ( t ) {C}^{T} ( t ) {- 1}^{} \\ \dot{P} ( t ) = - P ( t ) {C}^{T} ( t ) {- 1}^{} C ( t ) P ( t ) + A ( t ) P ( t ) + P ( t ) {A}^{T} ( t ) + 𝒬\end{matrix}$$

$$\hat{x} ( t ) := {[ {\hat{v}}^{T} ( t ) , {\hat{ω}}_{E , xy}^{T} ( t ) , {\hat{b}}_{m}^{T} ( t ) , {\hat{b}}_{ω}^{T} ( t ) ]}^{T} ∈ {12}^{}$$

$${\hat{ω}}_{E} ( t ) = {\hat{ω}}_{E , xy} ( t ) + α \hat{v} ( t )$$

$$A ( t ) = {[ \begin{matrix}0 & 0 \\ S [ m ( t ) ] & S [ {ω}_{m} ( t ) - α m ( t ) ] \\ - S [ {ω}_{m} ( t ) ] & 0 \\ S [ m ( t ) ] & 0\end{matrix} \vert 0 ]}^{T} ∈ {12 \times 12}^{}$$

$$B ( t ) = [ \begin{matrix}- S [ {ω}_{m} ( t ) ] \\ 0\end{matrix} ] ∈ {12 \times 3}^{}$$

$$C ( t ) = [ \begin{matrix}I & 0 & I & 0 \\ 0 & {m}^{T} ( t ) & 0 & 0\end{matrix} ] ∈ {4 \times 12}^{}$$

$$u ( t ) ≡ m ( t )$$

$$y ( t ) = [ \begin{matrix}m ( t ) \\ 0\end{matrix} ] ∈ {4}^{}$$

the attitude observer comprises:

\dot{\hat{R}}(t)=\hat{R}(t)S[ωₘ(t)−\hat{b}_{ω}(t)−\hat{R}^{T}(t)^{I}ω_{E}+k_{ω}_{_{E}}S[\hat{ω}_{E}(t)]\hat{R}^{T}(t)^{I}ω_{E}+kᵥS[\hat{v}(t)]\hat{R}^{T}(t)^{I}v]
in the formula, ωₘ(t) and m(t) are inputs of the Kalman filter, \hat{x}(t) is an output of the Kalman filter, ωₘ(t) represents the angular velocity of a rigid body, m(t) represents a body-fixed measurement of a constant inertial reference vector, I represents the identity matrix, α represents a preset constant, \hat{v}(t) represents the estimated and bias-corrected inertial reference vector expressed in body-fixed coordinates, \hat{ω}_{E}(t)represents an estimation of the Earth angular velocity expressed in body-fixed coordinates, \hat{b}_{ω}(t) represents an estimation of the bias offset associated with the angular velocity measurements, \hat{b}ₘ(t)represents an estimation of the bias offset associated with the body-fixed measurements of the inertial reference vector, Q represents the covariance matrix of the process noise, Q ε [symbol] ^{12×12}, and Q is a positive definite matrix, [symbol] represents the covariance matrix of the observation noise, [symbol] ε [symbol] ^{4×4}, and [symbol] is a positive definite matrix, [symbol] represents the Kalman gain matrix, [symbol] ε [symbol] ^{12×4}, S[m(t)] represents the antisymmetric matrix of m(t), and \dot{\hat{x}}(t) represents the derivative of \hat{x}(t) with respect to time t;
ωₘ(t), \hat{v}(t), \hat{ω}_{E}(t), \hat{b}ₘ(t), \hat{b}_{ω}(t), ^{I}ω_{E} and ^{I}v are inputs of the attitude observer, \hat{R}(t) is an output of the attitude observer, \hat{R}(t) represents the estimated rotation matrix of the rigid body, \dot{\hat{R}}(t) represents the derivative of \hat{R}(t) with respect to time t, k_{ω}_{_{E}} and kᵥ represent positive tuning parameters, ^{I}ω_{E} represents the Earth angular velocity expressed in inertial coordinates, ^{I}v represents the constant inertial reference vector.

In order to solve the technical problem, the invention adopts another technical solution of a computer-readable storage medium having stored thereon a computer program which, when executed by a processor, implements the steps of the above attitude estimation method.

The advantageous effect of the present invention is that by means of single observations of a constant inertial reference vector, e.g., direction of gravitational acceleration, and body-fixed measurements of angular velocity of a rigid body, an output comprising an estimated bias-corrected inertial reference vector expressed in body-fixed coordinates, an estimation of the Earth angular velocity expressed in body-fixed coordinates, and two bias offsets associated with the two sensors involved can be obtained from a preset Kalman filter; then the rotation matrix of the rigid body can be determined according to the estimated bias-corrected body-fixed inertial reference vector, the estimation of the Earth angular velocity expressed in body-fixed coordinates, the bias offset associated with the angular velocity sensor, and two preset inertial reference vectors; in the estimation process, only one constant inertial reference vector needs to be measured explicitly in body-fixed coordinates, and the geometric relationship between the inertial reference vector and the inertial representation of the Earth's angular velocity is used to greatly simplify the complexity of the attitude estimation algorithm. Meanwhile, the time-varying characteristics of the Kalman filter help to avoid tedious empirical gain adjustment processes often relying on sets of piecewise constant gains, improve the convergence speed of the algorithm, and ensure the accuracy of the attitude estimates.

### BRIEF DESCRIPTION OF THE DRAWINGS

FIG. 1 is a flow chart showing the steps of a method for estimating attitude according to an embodiment of the present invention.

FIG. 2 is a schematic diagram of three reference systems according to an embodiment of the present invention.

FIG. 3 is a schematic diagram of a cascade architecture for performing attitude estimation in an embodiment of the present invention.

FIG. 4 is a graph showing the evolution of estimation error \tilde{v}(t) when a simulation is carried out in an embodiment of the present invention.

FIG. 5 is a graph showing the evolution of estimation error \tilde{ω}_{E,xy}(t)when a simulation is carried out in an embodiment of the present invention.

FIG. 6 is a graph showing the evolution of estimation error \tilde{b}ₘ(t)when a simulation is carried out in an embodiment of the present invention.

FIG. 7 is a graph showing the evolution of estimation error \tilde{b}_{ω}(t)when a simulation is carried out in an embodiment of the present invention.

FIG. 8 is a graph showing the evolution of estimation error \tilde{R}(t) of the rotation matrix when a simulation is performed according to an embodiment of the present invention.

FIG. 9 is a graph showing the evolution of the resulting angular deviation \tilde{θ}(t) of the rotation matrix when a simulation is performed according to an embodiment of the present invention.

FIG. 10 is a schematic view of a robotic platform during an experiment according to an embodiment of the present invention.

FIG. 11 is a schematic diagram of ground truth data corresponding to the angular velocity of an MRT when an experiment is performed according to an embodiment of the present invention.

FIG. 12 is a graph showing the evolution of the estimation error \tilde{v}(t)when an experiment is performed according to an embodiment of the present invention.

FIG. 13 is a graph showing the evolution of an estimation error \tilde{ω}_{E,xy}(t) when an experiment is performed according to an embodiment of the present invention.

FIG. 14 is a graph showing the evolution of an estimate \hat{b}ₘ(t) when an experiment is performed according to an embodiment of the present invention.

FIG. 15 is a graph showing the evolution of an estimate \hat{b}_{ω}(t) when an experiment is performed according to an embodiment of the present invention.

FIG. 16 is a graph showing the evolution of the norm of the estimated body-fixed Earth angular velocity ∥\hat{ω}_{E}(t)∥ when an experiment is performed according to an embodiment of the present invention.

FIG. 17 is a graph showing the evolution of an estimation error \tilde{R}(t) when an experiment is performed according to an embodiment of the present invention.

FIG. 18 is a graph showing the evolution of a resulting angular deviation \tilde{θ}(t) of the rotation matrix when an experiment is performed according to an embodiment of the present invention.

FIG. 19 is a configuration diagram of an attitude estimation terminal according to an embodiment of the present invention.

### DETAILED DESCRIPTION OF THE EMBODIMENTS

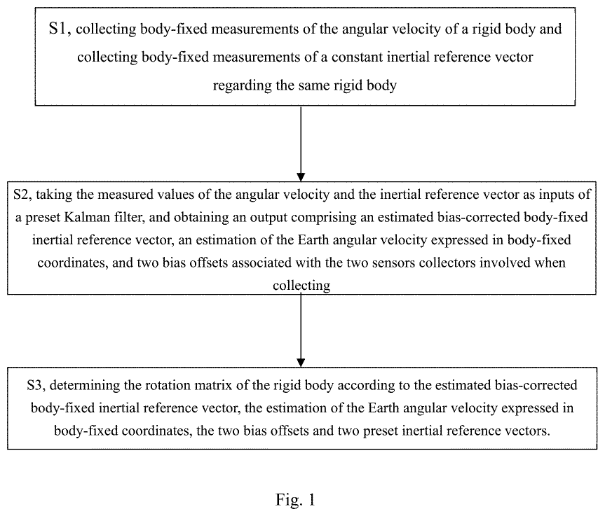

The above-mentioned attitude estimation method, terminal, system and computer-readable storage medium of the present invention can be applied to application scenarios requiring attitude estimation, such as navigation of underwater vehicles, offshore platform stabilization, Earth satellite alignment, etc., and the following is described by way of specific embodiments:
in some alternative embodiments, referring to FIG. 1, an attitude estimation method includes the steps of:

S1, collecting body-fixed measurements of the angular velocity of a rigid body and collecting body-fixed measurements of a constant inertial reference vector regarding the same rigid body;
in the present embodiment, the rigid body is a robotic platform performing a three-dimensional rotary motion in a dynamic environment, the platform is provided with a set of three orthogonally mounted high-grade rate gyroscopes, the accuracy of which is sufficient to sense the angular velocity of the Earth, for implicitly measuring the angular velocity of the Earth observed on the robotic platform's own coordinated framework, as well as the angular velocity of the rigid body in the present step, and in addition, the platform is also provided with a three-axis inertial sensor, by means of which a constant inertial reference vector is measured in the body-fixed coordinate frame, such as the direction of the Earth's magnetic field or the direction of the Earth's gravitational field;

S2, taking the measured values of the angular velocity and the inertial reference vector as inputs of a preset Kalman filter, and obtaining an output comprising an estimated bias-corrected body-fixed inertial reference vector, an estimation of the Earth angular velocity expressed in body-fixed coordinates, and two bias offsets associated with the two collectors involved when collecting, in some embodiments, the collectors are sensors;

S3, determining the rotation matrix of the rigid body according to the estimated bias-corrected body-fixed inertial reference vector, the estimation of the Earth angular velocity expressed in body-fixed coordinates, the two bias offsets and two preset inertial reference vectors.

In a specific implementation, firstly, three reference frames are preset, the first one is an inertial reference frame, which is denoted as {I}, and the second one is a reference frame fixed to the body of the robotic platform, which is denoted as {B}, and it is assumed that R(t) represents a rotation matrix from {B} to {I}, R(t) ε SO(3), SO(3):={X ε [symbol] ^{3×3}; XX^{T}=X^{T}X=I, det(X)=1} represents the special orthogonal group of order three, I represents the identity matrix, T represents the transpose operator, and [symbol] ^{3×3} represents the set of 3-by-3 real matrices;

A main object of the embodiment is to determine R(t) using the angular velocity measured by a set of high-grade rate gyroscopes, and using the measurements of some constant inertial reference vector obtained from a three-axis inertial sensor.

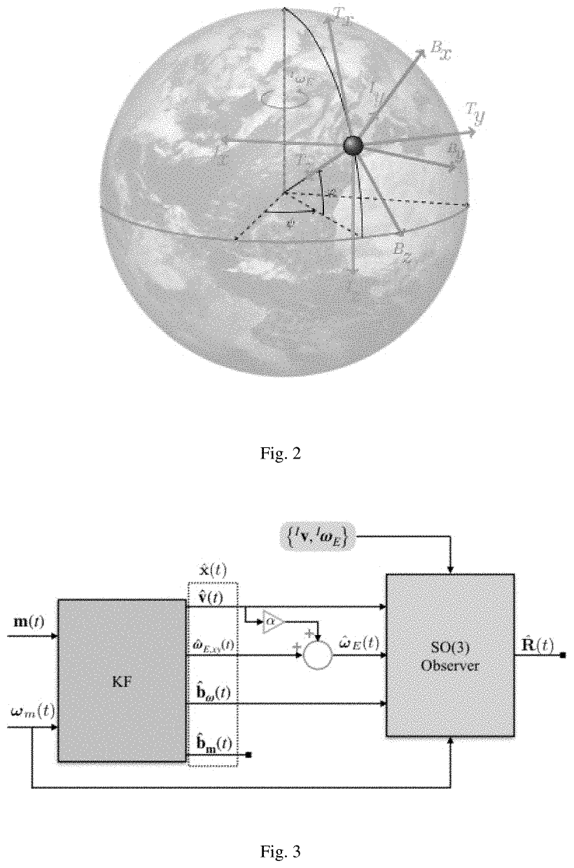

The third frame of reference is a navigation coordinate system, denoted as {T}, which follows the NED convention, i.e., the right-hand rule, similar to {T}, the coordinate reference frames {I} and {B} also follow the NED convention, the positive direction of their z-axis corresponding to the downward direction, and FIG. 2 shows the relationship between the three frames of reference;
let ^{T}v ε [symbol] ³ represent a constant inertial reference vector expressed in {T};
for ease of labeling, and since most equations are generated in {B}, whenever a quantity is expressed in frame of reference {B}, the leading superscript B is omitted, i.e., if there is no leading superscript B, the vector is implicitly expressed in frame {B}, i.e., v≡Bv;

the inertial reference frame {I} should be such that ^{T}vhas only a downward component when expressed in {I}, i.e.,

^{I}v=[0,0,ν]^{T}
wherein v:=∥^{T}v∥=∥^{I}v∥ is a known positive scalar;
two unit vectors are defined: ^{T}v:=^{T}v/ν, ^{I}v:=^{I}v/ν, then, accordingly, a constant rotation matrix from {T} to {I} denoted as _{T}^{I}R ε SO(3):

$${}_{T}^{I} R = I + S [ {}^{T} v \times {}^{I} v ] + {S}^{2} [ {}^{T} v \times {}^{I} v ] \frac{1 {-}^{T} {v}^{T} {}^{I} v}{{‖ {}^{T} v \times {}^{I} v ‖}^{2}} \qquad ( 1 )$$

wherein S[ ] is defined as follows:
an antisymmetric matrix of a vector a ε [symbol] ³ is defined as S[a] such that given another vector b ε [symbol] ³, the cross product of vectors a and b is: a×b=S[a]b;

The derivative with respect to time t of R(t)is:

\dot{R}(t)=R(t)S[ω(t)] (2)
in the formula, ω(t) ε [symbol] ³ is the angular velocity of {B} relative to {I}, as expressed in {B}, and the angular velocity of the rigid body measured by the high-order rate gyroscope is represented by the following formula:

ωₘ(t)=ω(t)+ω_{E}(t)+b_{ω}+n_{ω}(t) (3)
in the formula, ω_{E}(t) ε [symbol] ³ represents the angular velocity of the Earth around its own axis, expressed in {B}, b_{ω}ε [symbol] ³ represents a constant sensor bias offset associated with the high-grade rate gyroscopes, and n_{ω}(t) ε [symbol] ³ represents sensor noise that follows a zero mean, white Gaussian noise distribution in the embodiment;
let m(t) ε [symbol] ³ denote the body-fixed measurements of the constant inertial reference vector, i.e., ^{I}v, the inertial reference vector measured by the three-axis inertial sensor, expressed in body-fixed coordinates, is:

m(t)=v(t)+bₘ+nₘ(t) (4)
in the formula, v(t) is the body-fixed representation of the inertial reference vector, bₘ ε [symbol] ³ represents the constant sensor bias offset of the three-axis inertial sensor, and nₘ ε [symbol] ³ represents the corresponding sensor noise that follows from a zero mean, white Gaussian noise distribution;
according to the definition of R(t), for all t≥0, there are:

$$\{ \begin{matrix}{ω}_{E} ( t ) = {R}^{T} ( t ) {}_{}^{I} {ω}_{E}^{} & ( 5 a ) \\ v ( t ) = {R}^{T} ( t ) {}^{I} v . & ( 5 b )\end{matrix}$$

in the formula, ^{I}ω_{E} represents the Earth angular velocity expressed in {I} and ^{I}v represents the inertial reference vector, both of which are known quantities;
in the embodiment, ^{I}ω_{E} and ^{I}v are not collinear, i.e.,

^{I}ω_{E}×^{I}v≠0
for all t≥0, the sensor bias offset bₘ satisfies the following condition:

∥bₘ∥<<∥v(t)∥=∥═v∥=ν
according to FIG. 2, at a given latitude φ ε [symbol] , the inertial Earth angular velocity is given as follows:

^{I}ω_{E}=_{T}^{I}R∥^{I}ω_{E}∥[cos (φ),0,−sin (φ)]^{T}
ω_{E}(t) is written as a sum of two orthogonal components, one spanning the XY-plane of {B} and the other spanning the Z-plane of {B}, resulting in:

ω_{E}(t)=ω_{E,xy}(t)+ω_{E,z}(t) (6)
according to the formula above, the following can be obtained:

$$\{ \begin{matrix}{ω}_{E , xy} ( t ) := {{R}^{T} ( t ) [ {}^{I} {ω}_{E , x} , {}^{I} {ω}_{E , y} , 0 ]}^{T} & ( 7 a ) \\ {ω}_{E , z} ( t ) := {{R}^{T} ( t ) [ 0 , 0 , {}^{I} {ω}_{E , z} ]}^{T} & ( 7 b )\end{matrix}$$

the norms of the above-mentioned two vectors are both constant, and the inner product of ω_{E,xy}(t) and ω_{E,z}(t) is zero;
assuming that the two sensors used have no noise, the following can be obtained:

ω_{E,z}(t)−αv(t)−α(m(t)−bₘ), (8)
wherein α is a known constant, α:=−∥ω_{E,z}∥/ν<0; take the derivative of Equation (5b) and rewrite the result as:

0=\dot{R}(t)(m(t)−bₘ)+R(t)\dot{v}(t), (9)
ω(t) is determined according to Equation (3) and substituted into Equation (2) with the relevant parameters in Equation (9) being substituted, and note that the vector product of the parallel vectors is zero, resulting in:

\dot{v}(t)=−S[ωₘ(t)−ω_{E,xy}(t)−b_{ω}](m(t)−bₘ) (10)
the same derivation is carried out on Equation (7a) to obtain:

\dot{ω}_{E,xy}(t)=−S[ωₘ(t)−ω_{E,z}(t)−b_{ω}]ω_{E,xy}(t)
according to formula (8), the above Equation can be written as:

\dot{ω}_{E,xy}9′t)=−S[ωₘ(t)−α(m(t)−bₘ)−b_{ω}]ω_{E,xy}(t) (11)
to design a linear time-varying LTV system, formula (10) is written as:

\dot{v}(t)=−S[ωₘ9t)](m(t)−bₘ)+S[ω_{E,xy}(t)+b_{ω}](m(t)−bₘ), (12)
as ∥bₘ∥<<m(t). S[ω_{E,xy}(t)+b_{ω}]bₘ≈0;
likewise, in Equation (11), since the magnitude of bₘ is generally within the noise range associated with ωₘ(t), S[αbₘ−b_{ω}]ω_{E,xy}(t)≈0, in other words, in practice, the vector product between sensor offsets and between each offset and the XY component of the Earth angular velocity, is an order of magnitude less than the magnitude of the other vectors; thus, Equations (11) and (12) can be reduced to:

\dot{v}(t)≈−S[ωₘ(t)−Ω_{E,xy}(t)+b_{ω}]m(t)+S[ωₘ(t)]bₘ, (13)
and

\dot{ω}_{E,xy}(t)≈−S[ωₘ(t)−αm(t)]ω_{E,xy}(t) (14)

finally, a constraint on the Kalman filter is determined by the inner product of Equation (8) and ω_{E,xy}(t), i.e.,

0=ω_{E,xy}^{T}(t)(m(t)−bₘ)≈ω_{E,xy}^{T}(t)m(t) (15)
since the rotation speed of the Earth is a very small and constant value, the simplification performed by the Equations (13), (14) and (15) is feasible and does not constitute a practical limitation;
the state variable of the system is defined as:

x(t):=[v^{T}(t),ω_{E,xy}(t),bₘ^{T}(t),b_{ω}^{T}(t)]^{T}ε [symbol] ¹² (16)
on the basis of ignoring the sensor noise, the LTV system can be represented as:

$$\{ \begin{matrix}\dot{x} ( t ) = A ( t ) x ( t ) + B ( t ) u ( t ) \\ y ( t ) = C ( t ) x ( t )\end{matrix} \qquad ( 17 )$$

in the formula,

$$A ( t ) = {[ \begin{matrix}0 & 0 \\ S [ m ( t ) ] & S [ {ω}_{m} ( t ) - α m ( t ) ] \\ - S [ {ω}_{m} ( t ) ] & 0 \\ S [ m ( t ) ] & 0\end{matrix} \vert 0 ]}^{T} ∈ {12 \times 12}^{}$$

$$B ( t ) = [ \begin{matrix}- S [ {ω}_{m} ( t ) ] \\ 0\end{matrix} ] ∈ {12 \times 3}^{}$$

$$C ( t ) = [ \begin{matrix}I & 0 & I & 0 \\ 0 & {m}^{T} ( t ) & 0 & 0\end{matrix} ] ∈ {4 \times 12}^{}$$

$$u ( t ) ≡ m ( t )$$

$$y ( t ) = [ \begin{matrix}m ( t ) \\ 0\end{matrix} ] ∈ {4}^{}$$

To sum up, a linear time-varying system is designed;
the implementation of the Kalman filter is performed on the basis of the above-mentioned linear time-varying system, and specifically:
according to Equation (16), the integrated system state estimate can be represented as:

\hat{x}(t):=[\hat{v}^{T}(t),\hat{ω}_{E,xy}^{T}(t),\hat{b}ₘ^{T}(t),\hat{b}_{ω}^{T}(t)]^{T}ε [symbol] ¹² (18)
therefore, a typical Kalman filter obtained based on the LTV system denoted as the formula (17) can be represented as:

$$\{ \begin{matrix}\dot{\hat{x}} ( t ) = A ( t ) \hat{x} ( t ) + B ( t ) u ( t ) + ( t ) ( y ( t ) - C ( t ) \hat{x} ( t ) ) \\ ( t ) = P ( t ) {C}^{T} ( t ) {- 1}^{} \\ \dot{P} ( t ) = - P ( t ) {C}^{T} ( t ) {- 1}^{} C ( t ) P ( t ) + A ( t ) P ( t ) + P ( t ) {A}^{T} ( t ) +\end{matrix} \qquad ( 19 )$$

in the formula, ωₘ(t) and m(t) are input measurements of the Kalman filter, \hat{x}(t) is an output of the Kalman filter, ωₘ(t) represents the angular velocity of the rigid body, m(t) represents a body-fixed measurement value of the inertial reference vector, I represents an identity matrix, α represents a preset constant, \hat{v}(t) represents the body-fixed estimated inertial reference vector, \hat{ω}_{E}(t) represents the Earth angular velocity estimation value, \hat{b}ₘ(t) represents an estimated bias offset associated with the inertial sensor, \hat{b}_{ω}(t) represents an estimated bias offset associated with the high-grade rate gyros, Q represents the covariance matrix of process noise, Q ε [symbol] ^{12×12}, and Q is a positive definite matrix, [symbol] represents the covariance matrix of the observation noise, [symbol] ε [symbol] ^{4×4}, and [symbol] is a positive definite matrix, S[m(t)] represents an antisymmetric matrix of m(t), and \hat{x}(t) represents the derivative of \hat{x}(t) with respect to time t;
from the output of the Kalman filter, the estimated value \hat{ω}_{E}(t) of the Earth angular velocity expressed in body-fixed coordinates can be obtained with reference to Equations (8) and (18):

\hat{ω}_{E}(t)=\hat{ω}_{E,xy}(t)+α\hat{v}(t) (20)
it is known that the Kalman filter can be designed to be asymptotically stable if certain observability criteria are met, especially for LTV systems, and that a globally exponentially stable error dynamics can be obtained if stronger observability criteria are met. It can be proved through theoretical derivation that the LTV system realized by Equation (17) in the present embodiment is uniformly and completely observable, so as to ensure that the Kalman filter realized by Equation (19) can theoretically provide almost global asymptotical stability.

In further alternative embodiments, a rotational matrix observer is considered as follows:

\dot{\hat{R}}(t)=\hat{R}(t)S[ωₘ(t)−\hat{b}_{ω}(t)−\hat{R}^{T}(t)^{I}ω_{E}+k_{ω}_{_{E}}S[\hat{ω}_{E}(t)]\hat{R}^{T}(t)^{I}ω_{E}+kᵥS[\hat{v}(t)]\hat{R}^{T}(t)^{I}v] (21)
in the formula, ωₘ(t), \hat{v}(t), \hat{ω}_{E}(t), \hat{b}ₘ(t), \hat{b}_{ω}(t), ^{I}ω_{E} and ^{I}v are inputs of the attitude observer, \hat{R}(t) is an output of the attitude observer, \hat{R}(t) represents the rotation matrix of the rigid body, \dot{\hat{R}}(t) represents the derivative of \hat{R}(t) with respect to time t, k_{ω}_{_{E}} and kᵥ represent positive tuning parameters, ^{I}ω_{E} represents the Earth angular velocity expressed in inertial coordinates, ^{I}v represents a constant inertial reference vector, the observer realizes a cascade structure of the provided attitude estimation scheme, the cascade structure comprises a Kalman filter and a rotation matrix observer as shown in FIG. 3.

It is proved theoretically that the designed attitude observer is locally input state stable (LISS) and almost globally asymptotically stable (AGAS).

In an embodiment, a real scene is simulated within the range of robotic platform attitude estimation, considering a robotic platform that describes a rotational motion in three-dimensional space, the angular velocity of which is represented as:

$$ω ( t ) = {[ 5 sin ( \frac{6 π}{180} t ) , sin ( \frac{2 π}{180} t ) , - 2 sin ( \frac{6}{5} \frac{π}{180} t ) ]}^{T} ( deg / s )$$

Further assuming that the robotic platform is located at latitude φ=38.777816°, longitude ψ=9.097570°, and at sea level, the corresponding norm of the inertial angular velocity of the planet is ∥^{T}ω_{E}∥=7.2921159×10⁻⁵ (rad/s), taking into account the length of time of the sun, about 15 (deg/hr); its vector representation in {I} can be given by Equation (6).

Assume that the robotic platform is equipped with a commercial KVH Fiber Optic Gyroscope (FOG) 1775 Inertial Measurement Unit (IMU), which has a three-axis accelerometer that can collect vector measurements of the gravitational acceleration, according to the sea level and latitude shown above, and according to the 1980 International Gravity Formula, the components of the gravitational induced inertial reference acceleration are as follows:

^{T}v=[0,0,9.800611]^{T}(m/s²)

To simulate the worst-case specifications of the KVH1775 with respect to its three-axis accelerometer, which is characterized by a random walk of velocity of 0.12 (mg/Hz), a zero-mean

Gaussian white noise sequence with a standard deviation of 0.0059 (m/s2) is added to all simulated accelerometer data assuming a sampling frequency of 25 Hz.

Angular velocity readings collected from the advanced rate gyro of the KVH 1775 were corrupted by angular random walk noise of 0.7 deg/hr/\sqrt{Hz}. For a sampling frequency of 25 Hz, the angular random walk noise translates approximately to a standard deviation of 0.972 milli-degrees per second given a rate integration configuration.

According also to the worst-case specifications of the KVH 1775 manufacturer, the two constant bias offsets are set to:

$$\{ \begin{matrix}{b}_{m} = 0 . {5 [ - 1 , 1 , 1 ]}^{T} & ( mg ) \\ {b}_{ω} = {[ 1 , - 1 , - 1 ]}^{T} & ( deg / hr )\end{matrix}$$

according to the Kalman filter denoted as the Equation (19), the initial state estimation is set to:

\dot{x}(t₀)=[m^{T}(t₀),0,0,0]^{T}
the initial state error covariance matrix is set to P(t₀)=diag(10⁻²I, 10⁻³I, 10⁻²I, 10⁻³I); finally, the process noise and the observation noise are set to Q=diag(10⁻⁸I, 10⁻⁸I, 10⁻¹²I, 10⁻¹²I) and [symbol] =diag(10⁻³I, 0.001) ; the above values are adjusted empirically for best performance;

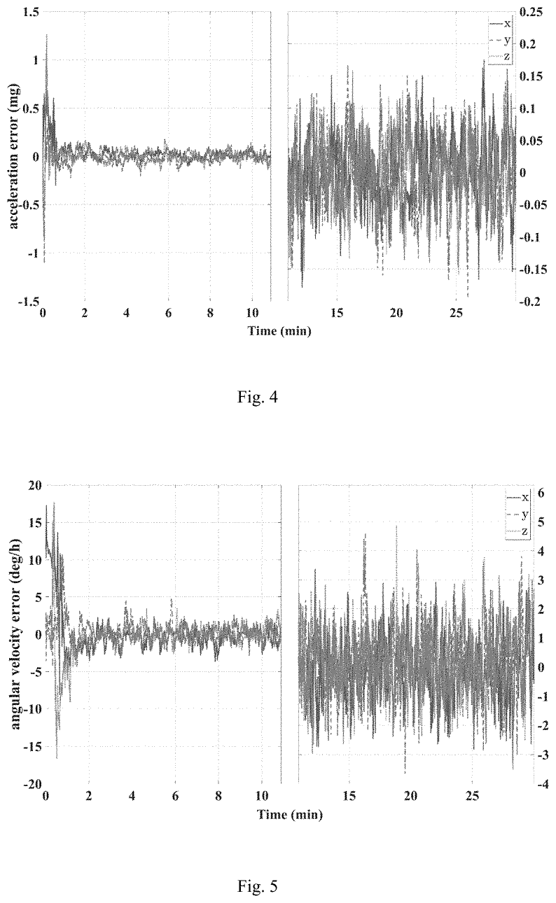

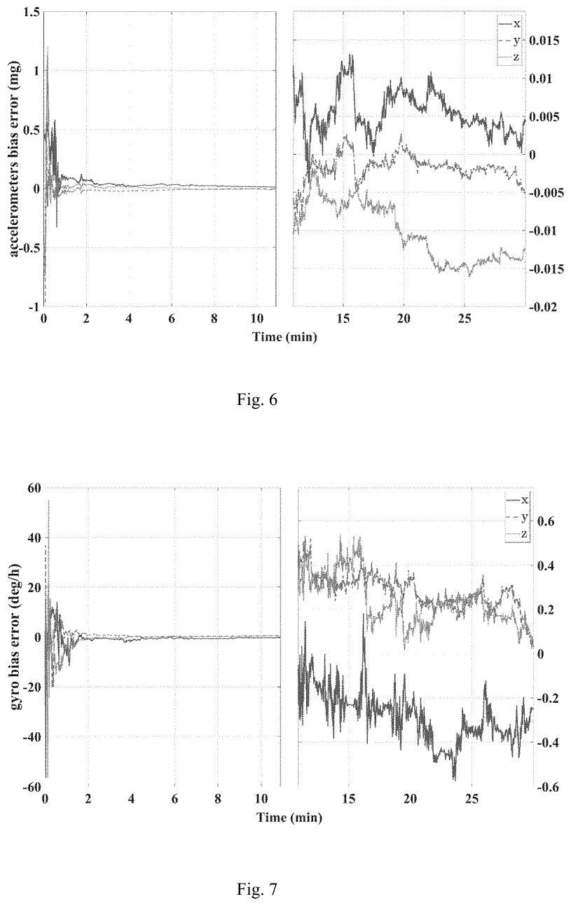

The graphs in FIGS. 4 to 7 show the evolution over 30 minutes of the four errors associated with the system state estimation shown by Equation (18), FIG. 4 shows the evolution of the estimation error \tilde{v}(t), FIG. 5 shows the evolution of the estimation error \tilde{ω}_{E,xy}(t), FIG. 6 shows the evolution of the estimation error \tilde{b}ₘ(t), and FIG. 7 shows the evolution of the estimation error \tilde{b}_{ω}(t).

In general, the convergence time was quite fast, and all error sequences reached steady state behavior around 5 minutes. This duration is extremely important because the rotation matrix observer is driven by the estimates of the Kalman filter (Equation 19). Table 1 provides further statistical observations of the given Kalman filter. For 25 (min) ≤t≤30 (min), the mean and standard deviation of each error variable across the three-dimensional Euclidean space is calculated and then averaged over the coordinates x, y and z. In addition, according to Equation (20), Table 1 also lists the average norm of the estimated value of the Earth angular velocity, and it is observed that the average norm of the estimated value of the Earth angular velocity is approximately 14.797 deg/hr (equivalent to a deviation of 1.353%), thereby confirming the high accuracy of the Kalman filter (Equation 19).

TABLE 1

| variable | mean | s.d. | units |
|---|---|---|---|
| v(t)-\hat{v}(t) | 0.0018137 | 0.051394 | mg |
| ω_{E,xy}(t)-\hat{ω}_{E,xy}(t) | 0.1094 | 1.0059 | deg/hr |
| bₘ-\hat{b}ₘ(t) | −0.003568 | 0.0014431 | mg |
| b_{ω}-\hat{b}_{ω}(t) | 0.014372 | 0.061086 | deg/hr |
| \|\|\hat{ω}_{E}(t)\|\| | 14.797 | 0.96482 | deg/hr |

In order to verify the robustness of the provided attitude estimation, an error \tilde{R}(t) between R(t) and \hat{R}(t) is represented in polar coordinates, \tilde{θ}(t) ε D:=[0,π]and \tilde{μ}(t) ε S(2) are assumed to constitute the Euler angle-axis pair of \tilde{R}(t), and the simulation is carried out when \tilde{θ}(t₀) is very large, with t₀ representing the initial time of the simulation;

Assuming a randomly generated unit vector \tilde{μ}(t), the initial angular deviation is set to \tilde{θ}(t₀)=175 degrees, and the corresponding initial rotation matrix estimate is calculated accordingly. Table 2 shows the observer gains, which are set in a piecewise manner. As the Kalman filter adjusts, the observer gains k_{ω}_{_{E}} and kᵥ are also empirically set to achieve the best performance.

TABLE 2

| time (min) | k_{ω}_{_{E}}\|\|^{I}ω_{E}\|\|² | kᵥ\|\|^{I}v\|\|² |
|---|---|---|
| t < 7.5 | 0.1 | 10 |
| 7.5 ≤ t < 15 | 0.01 | 5 |
| 15 ≤ t < 22.5 | 0.005 | 2.5 |
| t ≥ 22.5 | 0.001 | 1 |

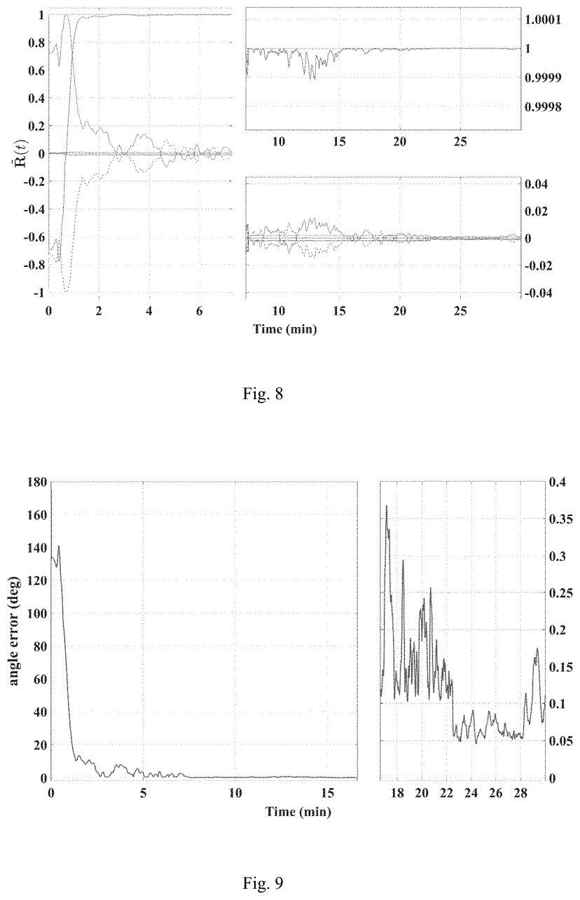

The graphs of FIGS. 8 and 9 show the detailed evolutions of \tilde{R}(t) and \tilde{θ}(t), respectively. It can be seen from the graph that the observer converges quickly, consistent with the performance of the Kalman filter. The rotation matrix error \tilde{R}(t) converges to the identity matrix, while the angle error \tilde{θ}(t) near the 10-minute mark has resolved the 1-degree neighborhood and is still decreasing; in fact, for 50 (min) ≤t<60 (min), the calculated mean value of the angular error is 0.124°, which confirms the good performance of the rotation matrix observer (Equation 21).

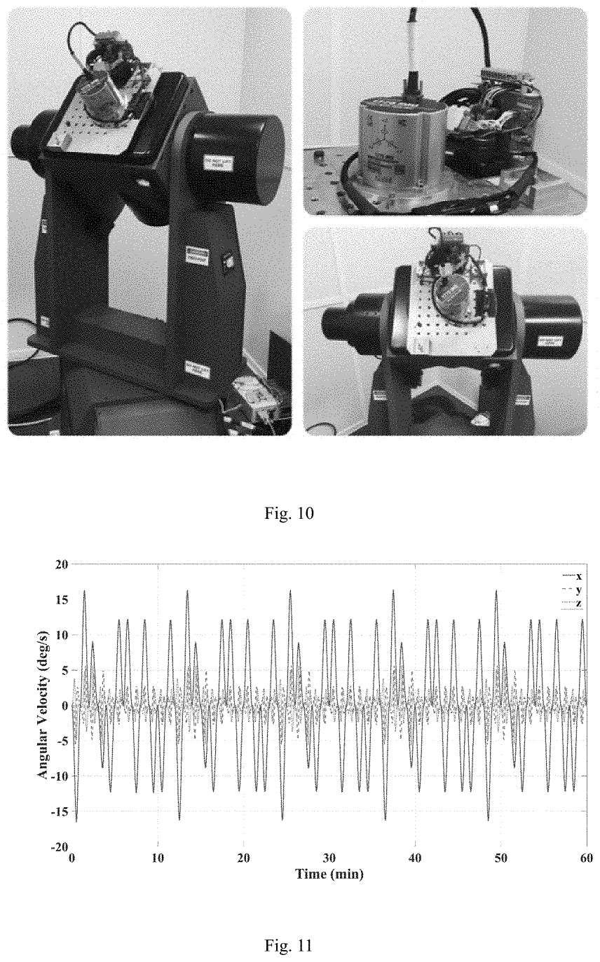

In an alternative embodiment, to verify the effectiveness of the cascaded attitude estimation solution, experiments were performed on the designed cascaded structure using a three-axis high precision FOG IMU KVH 1775 mounted on an Ideal Aerosmith Model 2103HT Three-Axis Positioning and Motion Rate Table (MRT) designed to provide accurate position, velocity and acceleration motion for IMU and inertial navigation system development and/or production testing and calibration. Ground-truth data from the MRT is characterized by a rate accuracy of 0.5%±0.0005 (deg/s) on the limited rotation axes (y and z), a rate accuracy of 0.01%±0.0005 (deg/s) on the unlimited rotation axis (x), and a position accuracy of 30 arc sec on all axes; FIG. 10 depicts the final experimental setup with the same geographical location as the previous embodiment.

KVH 1775 provides three axis readings of angular velocity and acceleration. A slow rotational motion is considered to ensure that the magnitude of the gravitational field is a dominant acceleration term. At room temperature, the accelerometer of the device is characterized by a random walk of speed of 0.12 (mg/\sqrt{Hz});
the inertial reference vectors ^{T}ω_{E}=[−0.9060, −11.7102, −9.3959]^{T} (deg/hr) and ^{T}v=[0.0170, −0.0049,9.8006]^{T} are obtained from a full calibration procedure of KVH 1775, according to Equation 1 the following can be obtained:

$${}_{T}^{I} R \approx [ \begin{matrix}1 & 0 & - 0.0017 \\ 0 & 1 & 0.0005 \\ 0.0017 & - 0.0005 & 1\end{matrix} ] ,$$

which means ^{I}ω_{E}=[−0.8897, −11.7149, −9.3916]^{T} (deg/hr).

With respect to sensor biases, bₘ and b_{ω} are also obtained during a full calibration of KVH 1775.

The data acquired from the MRT was taken at 128 Hz and then appropriately down-sampled to 25 Hz to match the sampling frequency of the KVH 1775;
the MRT is programmed to describe a rotational maneuver for approximately one hour, and FIG. 11 shows ground-truth data corresponding to the angular velocity of the MRT, as expressed in its own frame of reference.

The tuning of the Kalman filter is as follows:
the initial state estimate is set to:

\hat{x}(t₀)=[m^{T}(t₀),0,0,0]^{T}
the initial state error covariance matrix is set to P(t₀)=diag(10⁻²I, 10⁻⁶I, 10⁻³I, 10⁻⁶I); finally, the process noise and the observation noise are set to:

Q=diag(10⁻⁶I, 10⁻¹³I, 10⁻¹⁶I, 10⁻¹⁶I) and [symbol] =diag(10⁻⁷I, 10⁻⁷);
these values were adjusted empirically for best performance, and the rotation matrix observer gains were also set in a piecewise fashion in the experiments, as shown in Table 3.

TABLE 3

| time (min) | k_{ω}_{_{E}}\|\|^{I}ω_{E}\|\|² | kᵥ\|\|^{I}v\|\|² |
|---|---|---|
| t < 7.5 | 0.02 | 20 |
| 7.5 ≤ t < 15 | 0.005 | 15 |
| 15 ≤ t < 22.5 | 0.001 | 5 |
| 22.5 ≤ t < 30 | 7.5 × 10⁻⁴ | 2.5 |
| 30 ≤ t < 50 | 1 × 10⁻⁴ | 2.5 |
| t ≥ 50 | 1 × 10⁻⁵ | 1 |

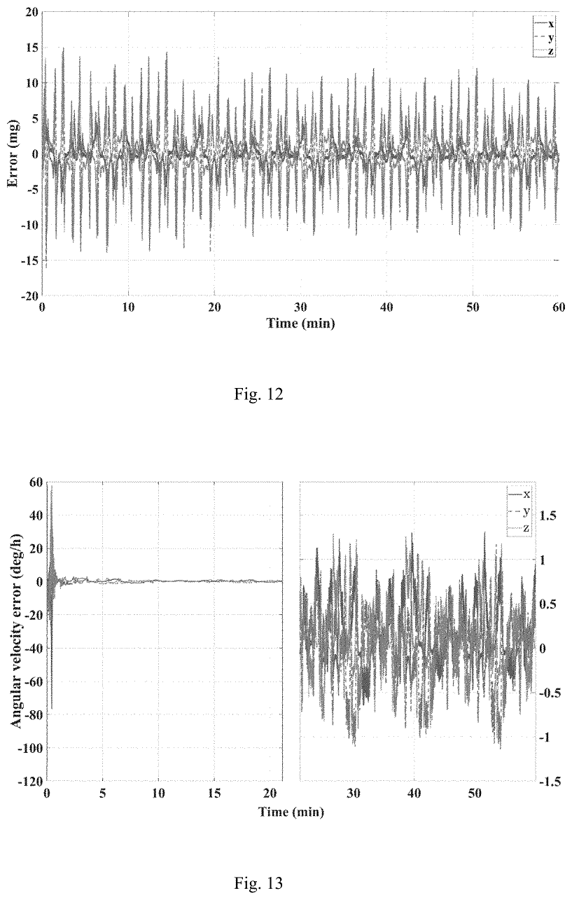

FIG. 12 shows the evolution of the estimation error \hat{v}(t) related to the acceleration of gravity expressed in body-fixed coordinates, and a quick comparison with the corresponding simulation results shown in FIG. 4 shows that the experimental accuracy is lower, however, this difference may in fact result from some unaccounted for apparent acceleration and/or some degree of inaccuracy related to the inertial reference vector ^{T}v obtained from the calibration, and may also result from synchronization errors between the MRT data and the filter estimation, which is quite obvious from the viewpoint of the periodicity of the errors;

On the other hand, the experimental estimated value of ω_{E,xy}(t) is in good agreement with the simulation results. FIG. 13 shows the evolution of the estimation error \tilde{ω}_{E,xy}(t), and it can be seen from Table 3 that the error remains below 1 (deg/hr) most of the time, and the steady-state accuracy is around 0.4 (deg/hr), which fully illustrates the high efficiency and high accuracy performance of the Kalman filter (19) in practical applications.

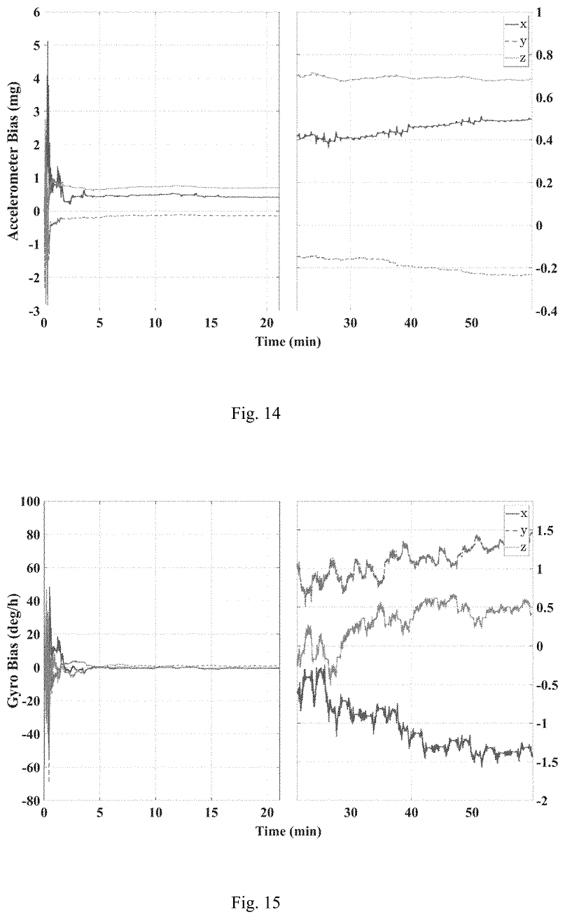

The evolutions of the estimation error \tilde{b}ₘ(t) and the estimation error \tilde{b}_{ω}(t) are shown in FIGS. 14 and 15, respectively. It can be seen from these two graphs that although the deviation is assumed to be constant, the deviation will vary slightly over time, which is consistent with expectations, further demonstrating that the designed Kalman filter can track slow variations. Nevertheless, the experimental results are similar to the qualitative predictions previously described. In fact, the z component of bₘ(t) converges to 0.75 mg, while the magnitude of the other two components is smaller; the maximum bias offset specified by the manufacturer of the KVH 1775 is ±0.5 mg, which means that the overshoot is not only due to the performance of the angular rate gyros but also to the accuracy of the MRT. With respect to b_{ω}(t), the y and z components are close to each other and exhibit mirrored behavior, while the x component evolves towards a negative value of −1.5 deg/hr.

In general, the designed Kalman filter provides a consistent estimate of the bias of both sensors. Furthermore, the next step on the results of the rotation matrix estimation will further prove the effectiveness of the Kalman filter.

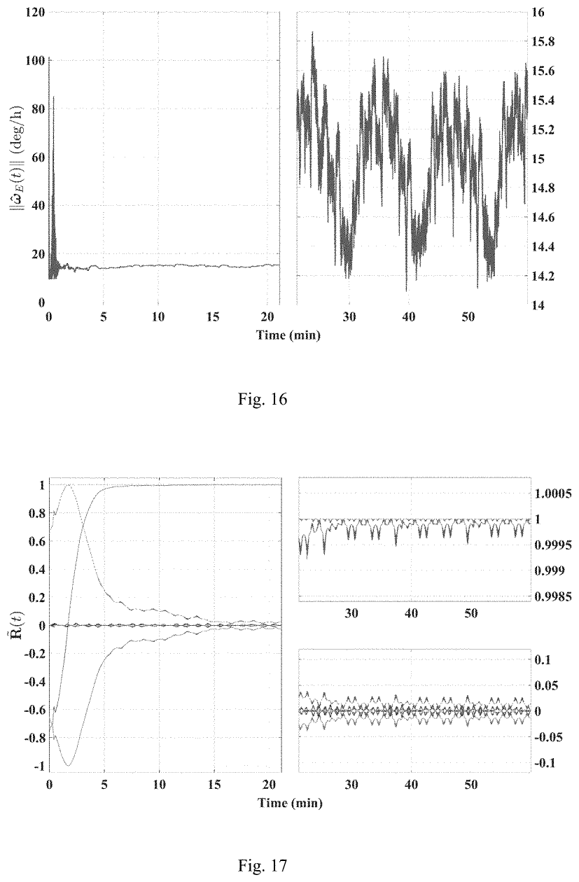

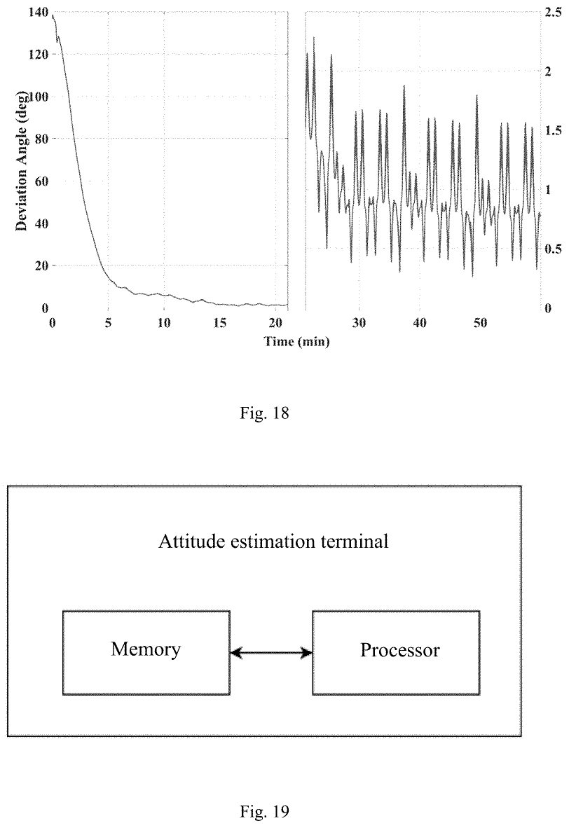

For completeness, FIG. 16 shows the evolution of the norm of the estimated angular velocity of the Earth, the experimental results are very close to the actual 15 deg/hr, as evidenced by the mean and standard deviation values shown in row 5 of Table 4.

TABLE 4

| variable | mean | s.d. | units |
|---|---|---|---|
| v(t)-\hat{v}(t) | 0.0011167 | 1.7507 | mg |
| ω_{E,xy}(t)-\hat{ω}_{E,xy}(t) | 0.055817 | 0.39762 | deg/hr |
| \|\|\hat{b}ₘ(t)\|\| | 0.86663 | 0.0076772 | mg |
| \|\|\hat{b}_{ω}(t)\|\| | 1.8711 | 0.1065 | deg/hr |
| \|\|\hat{ω}_{E}(t)\|\| | 14.922 | 0.34267 | deg/hr |
| \hat{θ}(t) | 0.40751 | 0.16467 | deg |

The initial rotation matrix is estimated so that the corresponding initial angular deviation thereof is about 128°, as shown in FIG. 17, \tilde{R}(t)converges in about 10 minutes tosteady-state behaviour, and finally approximates the identity matrix; equivalently, the evolution of the angle error\tilde{θ}(t)remains close to the neighborhood of zero; it displays a fast initial convergence and its large initial deviation is corrected in a few minutes. Furthermore, as shown in Table 4, the calculated average angle deviation for 45 (min)≤t≤60 (min) is 0.40751 degrees, again demonstrating that the provided cascade structure can reach a high level of accuracy.

In another alternative implementation, as shown in FIG. 19, an attitude estimation terminal comprising a memory, a processor and a computer program stored on the memory and executable on the processor, which when executed implements the steps of the above-mentioned attitude estimation method.

In summary, the present invention provides an attitude estimation method, a terminal, a system and a computer-readable storage medium, and for the problem of estimating attitude and sensor biases, a cascading solution method is provided, wherein the first part of the cascade is a Kalman filter applied to an LTV system. The second part of the cascade is characterized by a nonlinear attitude observer based on SO(3). In addition to the estimates of the Kalman filter, the observer is also driven by angular velocity measurements provided by a set of three high-grade rate gyros. It is proved that the nonlinear attitude observer is LISS with respect to the Kalman filter estimates. The simulation results show the effectiveness of the algorithm. The experimental results further prove the effectiveness of the above attitude estimation algorithm, which can be applied to applications requiring high-efficiency and high-precision attitude data.

While the foregoing is directed to embodiments of the present invention, other and further embodiments of the invention may be devised without departing from the basic scope thereof, and the scope thereof is determined by the claims that follow.

What is claimed is:

1. An attitude estimation method, comprising:
collecting body-fixed measurements of the angular velocity of a rigid body and collecting body-fixed measurements of a constant inertial reference vector regarding the same rigid body;
taking the measured values of the angular velocity and the inertial reference vector as inputs of a preset Kalman filter, and obtaining an output comprising an estimated and bias-corrected body-fixed inertial reference vector, an estimation of the Earth angular velocity expressed in body-fixed coordinates, and two bias offsets associated with the two collectors involved when collecting; and
determining the rotation matrix of the rigid body according to the estimated bias-corrected body-fixed inertial reference vector, the estimation of the Earth angular velocity expressed in body-fixed coordinates, the two bias offsets and two preset inertial reference vectors.

2. The attitude estimation method according to claim 1, wherein the inertial reference vector includes an inertial reference angular velocity and an inertial reference acceleration.

3. The attitude estimation method according to claim 1, further comprising deriving a bias offset that determines a measurement of the inertial reference acceleration.

4. The attitude estimation method according to claim 3, wherein the Kalman filter comprises:
$$\{ \begin{matrix}\dot{\hat{x}} ( t ) = A ( t ) \hat{x} ( t ) + B ( t ) u ( t ) + ( t ) ( y ( t ) - C ( t ) \hat{x} ( t ) ) \\ ( t ) = P ( t ) {C}^{T} ( t ) {- 1}^{} \\ \dot{P} ( t ) = - P ( t ) {C}^{T} ( t ) {- 1}^{} C ( t ) P ( t ) + A ( t ) P ( t ) + P ( t ) {A}^{T} ( t ) +\end{matrix}$$
$$\hat{x} ( t ) := {[ {\hat{v}}^{T} ( t ) , {\hat{ω}}_{E , xy}^{T} ( t ) , {\hat{b}}_{m}^{T} ( t ) , {\hat{b}}_{ω}^{T} ( t ) ]}^{T} ∈ {12}^{}$$
$${\hat{ω}}_{E} ( t ) = {\hat{ω}}_{E , xy} ( t ) + α \hat{v} ( t )$$
$$A ( t ) = {[ \begin{matrix}0 & 0 \\ S [ m ( t ) ] & S [ {ω}_{m} ( t ) - α m ( t ) ] \\ - S [ {ω}_{m} ( t ) ] & 0 \\ S [ m ( t ) ] & 0\end{matrix} \vert 0 ]}^{T} ∈ {12 \times 12}^{}$$
$$B ( t ) = [ \begin{matrix}- S [ {ω}_{m} ( t ) ] \\ 0\end{matrix} ] ∈ {12 \times 3}^{}$$
$$C ( t ) = [ \begin{matrix}I & 0 & I & 0 \\ 0 & {m}^{T} ( t ) & 0 & 0\end{matrix} ] ∈ {4 \times 12}^{}$$
$$u ( t ) ≡ m ( t )$$
$$y ( t ) = [ \begin{matrix}m ( t ) \\ 0\end{matrix} ] ∈ {4}^{}$$
in the formula, ωₘ(t) and m(t) are inputs of the Kalman filter, \hat{x}(t) is an output of the Kalman filter, ωₘ(t) represents the angular velocity of the rigid body, m(t) represents the body-fixed measurement of the constant inertial reference vector, I represents the identity matrix, α represents a preset constant, \hat{v}(t) represents the estimated bias-corrected inertial reference vector expressed in body-fixed coordinates, \hat{ω}_{E}(t) represents an estimation of the Earth angular velocity expressed in body-fixed coordinates, \hat{b}_{ω}(t) represents an estimation of the bias offset associated with the angular velocity measurements, \hat{b}ₘ(t) represents an estimation of the bias offset associated with the body-fixed measurements of the inertial reference vector, Q represents the covariance matrix of the process noise, Q ε [symbol] ^{12×12}, and Q is a positive definite matrix, [symbol] represents the covariance matrix of the observation noise, [symbol] ε [symbol] ^{4×4}, and [symbol] is a positive definite matrix, [symbol] represents the Kalman gain matrix, [symbol] ε [symbol] ^{12×5}, S[m(t)] represents the antisymmetric matrix of m(t), and \hat{\dot{x}}(t) represents the derivative of \hat{x}(t)with respect to time t.

5. The attitude estimation method according to claim 4, wherein the determining the rotation matrix of the rigid body according to the estimated bias-corrected body-fixed inertial reference vector, the estimation of the Earth angular velocity expressed in body-fixed coordinates, the two bias offsets and two preset inertial reference vectors comprises:
inputting estimated bias-corrected body-fixed inertial reference vector, the estimation of the Earth angular velocity expressed in body-fixed coordinates, the two bias offsets and the two preset inertial reference vectors to an attitude observer which is cascaded with the Kalman filter and is established on the third-order special orthogonal group, and determining a rotation matrix of the rigid body according to the output of the attitude observer.

6. The attitude estimation method according to claim 5, wherein the attitude observer comprises:
\dot{\hat{R}}(t)=\hat{R}(t)S[ωₘ(t)−\hat{b}_{ω}(t)−\hat{R}^{T}(t)^{I}ω_{E}+k_{ω}_{_{E}}S[\hat{ω}_{E}(t)]\hat{R}^{T}(t)^{I}ω_{E}+kᵥS[\hat{v}(t)]\hat{R}^{T}(t)^{I}v]
in the formula, \hat{R}(t) represents the rotation matrix of the rigid body, \dot{\hat{R}}(t) represents the derivative of \hat{R}(t) with respect to time t, k_{ω}_{_{E}} and kᵥ represent positive tuning parameters, ^{I}ω_{E} represents the Earth angular velocity expressed in inertial coordinates, and ^{I}v represents the constant inertial reference vector.

7. The attitude estimation method according to claim 1, wherein the object to be estimated comprises a robot, a vehicle or an earth satellite.

8. An attitude estimation terminal comprising a memory, a processor and a computer program stored on the memory and executable on the processor, wherein the processor, when executing the computer program, implements the steps of the attitude estimation method according to claim 1.

9. An attitude estimation terminal comprising a memory, a processor and a computer program stored on the memory and executable on the processor, wherein the processor, when executing the computer program, implements the steps of the attitude estimation method according to claim 2.

10. An attitude estimation terminal comprising a memory, a processor and a computer program stored on the memory and executable on the processor, wherein the processor, when executing the computer program, implements the steps of the attitude estimation method according to claim 3.

11. An attitude estimation terminal comprising a memory, a processor and a computer program stored on the memory and executable on the processor, wherein the processor, when executing the computer program, implements the steps of the attitude estimation method according to claim 4.

12. An attitude estimation terminal comprising a memory, a processor and a computer program stored on the memory and executable on the processor wherein the processor, when executing the computer program, implements the steps of the attitude estimation method according to claim 5.

13. An attitude estimation terminal comprising a memory, a processor and a computer program stored on the memory and executable on the processor, wherein the processor, when executing the computer program, implements the steps of the attitude estimation method according to claim 6.

14. An attitude estimation system, comprising a Kalman filter and an attitude observer based on the special orthogonal group of order three;
the Kalman filter is cascaded with the attitude observer;
the Kalman filter comprises:
$$\{ \begin{matrix}\dot{\hat{x}} ( t ) = A ( t ) \hat{x} ( t ) + B ( t ) u ( t ) + ( t ) ( y ( t ) - C ( t ) \hat{x} ( t ) ) \\ ( t ) = P ( t ) {C}^{T} ( t ) {- 1}^{} \\ \dot{P} ( t ) = - P ( t ) {C}^{T} ( t ) {- 1}^{} C ( t ) P ( t ) + A ( t ) P ( t ) + P ( t ) {A}^{T} ( t ) + 𝒬\end{matrix}$$
$$\hat{x} ( t ) := {[ {\hat{v}}^{T} ( t ) , {\hat{ω}}_{E , xy}^{T} ( t ) , {\hat{b}}_{m}^{T} ( t ) , {\hat{b}}_{ω}^{T} ( t ) ]}^{T} ∈ {12}^{}$$
$${\hat{ω}}_{E} ( t ) = {\hat{ω}}_{E , xy} ( t ) + α \hat{v} ( t )$$
$$A ( t ) = {[ \begin{matrix}0 & 0 \\ S [ m ( t ) ] & S [ {ω}_{m} ( t ) - α m ( t ) ] \\ - S [ {ω}_{m} ( t ) ] & 0 \\ S [ m ( t ) ] & 0\end{matrix} \vert 0 ]}^{T} ∈ {12 \times 12}^{}$$
$$B ( t ) = [ \begin{matrix}- S [ {ω}_{m} ( t ) ] \\ 0\end{matrix} ] ∈ {12 \times 3}^{}$$
$$C ( t ) = [ \begin{matrix}I & 0 & I & 0 \\ 0 & {m}^{T} ( t ) & 0 & 0\end{matrix} ] ∈ {4 \times 12}^{}$$
$$u ( t ) ≡ m ( t )$$
$$y ( t ) = [ \begin{matrix}m ( t ) \\ 0\end{matrix} ] ∈ {4}^{}$$
the attitude observer comprises:
\hat{\dot{R}}(t)=\hat{R}(t)S[ωₘ(t)−\hat{b}_{ω}(t)−\hat{R}^{T}(t)^{I}ω_{E}+k_{ω}_{_{E}}S[\hat{ω}_{E}(t)]\hat{R}^{T}(t)^{I}ω_{E}+kᵥS[\hat{v}(t)]\hat{R}^{T}(t)^{I}v]
in the formula, ωₘ(t) and m(t) are inputs of the Kalman filter, \hat{x}(t) is an output of the Kalman filter, ωₘ(t) represents the angular velocity of a rigid body, m(t) represents a body-fixed measurement of a constant inertial reference vector, I represents the identity matrix, α represents a preset constant, \hat{v}(t) represents the estimated and bias-corrected inertial reference vector expressed in body-fixed coordinates, \hat{ω}_{E}(t)represents an estimation of the Earth angular velocity expressed in body-fixed coordinates, \hat{b}_{ω}(t) represents an estimation of the bias offset associated with the angular velocity measurements, \hat{b}ₘ(t)represents an estimation of the bias offset associated with the body-fixed measurements of the inertial reference vector, Q represents the covariance matrix of the process noise, Q ε [symbol] ^{12×12}, and Q is a positive definite matrix, [symbol] represents the covariance matrix of the observation noise, [symbol] ε [symbol] ^{4×4}, and [symbol] is a positive definite matrix, [symbol] represents the Kalman gain matrix, [symbol] ε [symbol] ^{12×4}, S[m(t)] represents the antisymmetric matrix of m(t), and \dot{\hat{x}}(t) represents the derivative of \hat{x}(t)with respect to time t;
ωₘ(t), \hat{v}(t), \hat{ω}_{E}(t), \hat{b}ₘ(t), \hat{b}_{ω}(t), ^{I}ω_{E} and ^{I}v are inputs of the attitude observer, \hat{R}(t) is an output of the attitude observer, \hat{R}(t) represents the rotation matrix of the rigid body, \dot{\hat{R}}(t) represents the derivative of \hat{R}(t) with respect to time t, k_{ω}_{_{E}} and kᵥ represent positive tuning parameters, ^{I}ω_{E} represents the Earth angular velocity expressed in inertial coordinates, and ^{I}v represents some constant inertial reference vector.

15. A non-transitory computer-readable storage medium having a computer program stored thereon, wherein the computer program is executed by a processor, the steps of the attitude estimation method according to claim 1 are implemented.

16. A non-transitory computer-readable storage medium having a computer program stored thereon, wherein the computer program is executed by a processor, the steps of the attitude estimation method according to claim 2 are implemented.

17. A non-transitory computer-readable storage medium having a computer program stored thereon, wherein the computer program is executed by a processor, the steps of the attitude estimation method according to claim 3 are implemented.

18. A non-transitory computer-readable storage medium having a computer program stored thereon, wherein the computer program is executed by a processor, the steps of the attitude estimation method according to claim 4 are implemented.

19. A non-transitory computer-readable storage medium having a computer program stored thereon, wherein the computer program is executed by a processor, the steps of the attitude estimation method according to claim 5 are implemented.

20. A non-transitory computer-readable storage medium having a computer program stored thereon, wherein the computer program is executed by a processor, the steps of the attitude estimation method according to claim 6 are implemented.
